(19) United States
(12) Patent Application Publication
(10) Pub. No.: US 2009/0026326 A1
(43) Pub. Date: Jan. 29, 2009

(54) CABLE MANAGEMENT APPARATUS FOR FANS

(75) Inventor: ZHAN-YANG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD.; HON HAI PRECISION INDUSTRY CO., LTD., Tu-Cheng (TW)

(21) Appl. No.: 11/842,173

(22) Filed: Aug. 21, 2007

(30) Foreign Application Priority Data
Jul. 26, 2007 (CN) 200720200713.8

(51) Int. Cl. F16L 3/22; F24F 7/06

(52) U.S. Cl. 248/68.1; 454/228

(57) ABSTRACT

A cable management apparatus for managing a power cable (32) of a fan (30) includes an assembly bracket (22), and a hook (226). The assembly bracket is attached to the fan. The hook protrudes from the assembly bracket, for clasping the power cable. The hook includes a base portion (2262), a receiving portion (2264), a stopper portion (2266), and a guide portion (2268). The base portion extends away from the assembly bracket. The receiving portion extends from the base portion, the receiving portion and the assembly bracket cooperatively forms a receiving space for extension of the power cable therethrough. The stopper portion extends close to the assembly bracket from the receiving portion, for blocking the power cable escaping from the receiving space. The guide portion is connected to the stopper portion and extends away from the assembly bracket, for the power cable sliding into the receiving space.

### BACKGROUND

1. Field of the Invention

The present invention relates to cable management apparatuses, and more particularly to a cable management apparatus for a fan in a computer.

2. Description of Related Art

Nowadays, more and more fans are needed in a computer for dissipating heat to ensure normal running of the computer. The power cables of the fans are usually arranged along any convenient pathway for connecting to a motherboard in the computer. If the power cables of the fans are not managed, it will be disordered in the computer and the heat of the computer will not dissipate well. Conventionally, the power cables of the fans can be connected with other data cables via a binding accessory, and then connected to the motherboard in the computer. This will add to cost and sometimes effect dissipation of heat in the computer when the power cables and other data cables are arranged along the airflow pathways of the fans.

What is needed, therefore, is a simple low-cost cable management apparatus for managing a power cable of a fan in a computer.

### SUMMARY

A cable management apparatus for managing a power cable of a fan includes an assembly bracket and a hook. The assembly bracket is attached to the fan. The hook protrudes from the assembly bracket, for clasping the power cable. The hook includes a base portion, a receiving portion, a stopper portion, and a guide portion. The base portion extends away from the assembly bracket. The receiving portion extends from the base portion, the receiving portion and the assembly bracket cooperatively forms a receiving space for extension of the power cable therethrough. The stopper portion extends close to the assembly bracket from the receiving portion, for blocking the power cable escaping from the receiving space. The guide portion is connected to the stopper portion and extends away from the assembly bracket, for the power cable sliding into the receiving space.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an exploded, isometric view of a cable management apparatus in accordance with an embodiment of the present invention for managing a power cable of a fan in a computer enclosure;

FIG. 2 is an assembled view of the cable management apparatus of FIG. 1;

FIG. 3 is an assembled view of a top panel and the cable management apparatus of FIG. 1; and

FIG. 4 is an enlarged isometric view of a hook and the power cable in FIG. 2;

### DETAILED DESCRIPTION

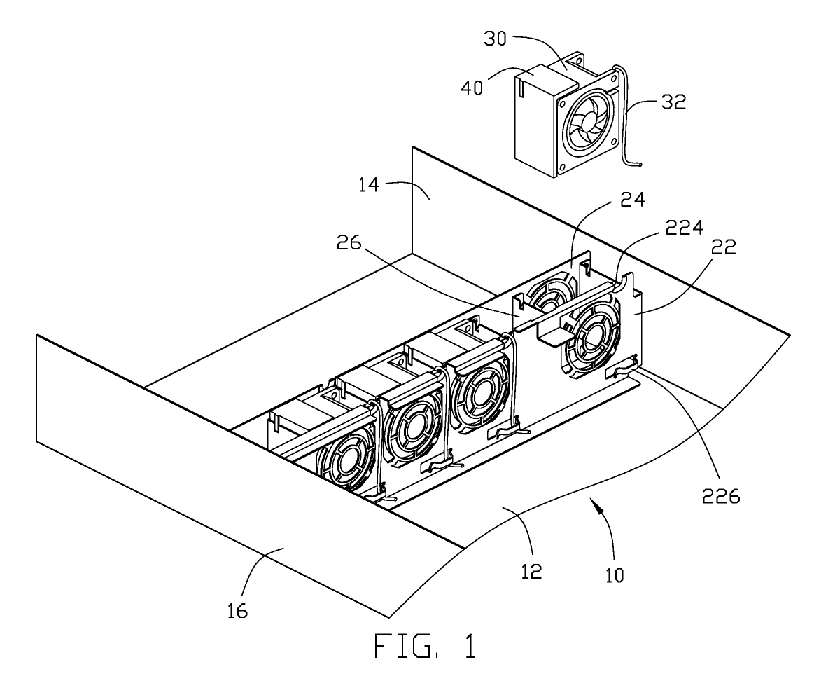

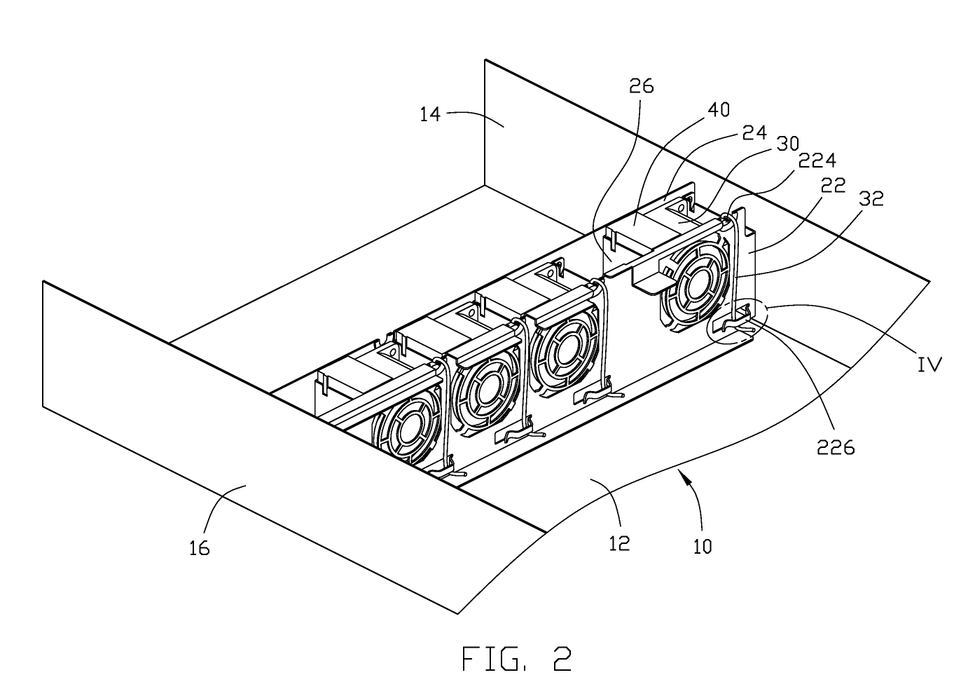

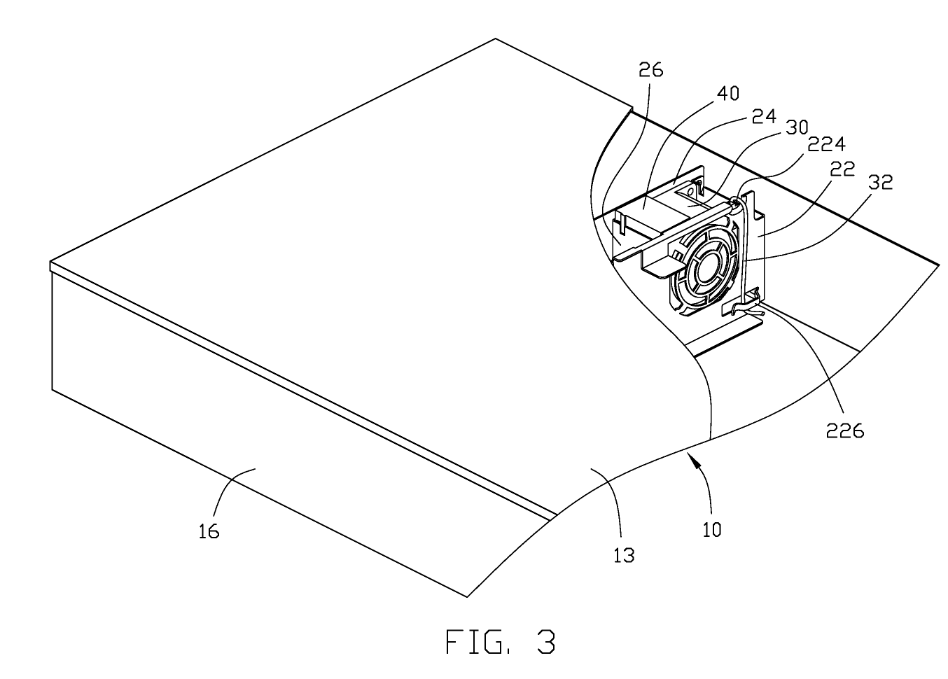

Referring to FIGS. 1, 2, and 3, a cable management apparatus of an embodiment of the present invention is used to arrange a power cable 32 of a fan 30 in a computer enclosure 10.

The computer enclosure 10 includes a base panel 12, a top panel 13 and two parallel side panels 14, 16 respectively extending from two opposite sides of the base panel 12 and generally perpendicular to the base panel 12. Two parallel assembly brackets 22, 24 are mounted perpendicular to the base panel 12 between the two side panels 14, 16. The assembly brackets 22, 24 are perpendicular to the side panels 14, 16, and a plurality of spaced openings for dissipating heat of the computer enclosure 10 is formed in the assembly bracket 22, in alignment with another plurality of spaced openings for dissipating heat of the computer enclosure 10 formed in the assembly bracket 24. A plurality of parallel fixing boards 26 is fixed perpendicularly between the assembly brackets 22, 24, for separating one opening from the adjacent opening of the assembly brackets 22, 24 in the computer enclosure 10. Each fan 30 is mounted between the two adjacent fixing boards 26 via a mounting member 40 and located in alignment with the corresponding two opposite openings of the two assembly brackets 22, 24. A hook 226 protrudes from the assembly bracket 22 under each opening on the assembly bracket 22, located around a low corner of the corresponding opening, for clasping the corresponding power cable 32 of the fan 30. A cutout 224 is defined in the assembly bracket 22 at an upper corner of each opening, and the cutout 224 and the hook 226 are at the same side of the opening. The power cable 32 of the fan 30 rides over the assembly bracket 22 through the cutout 224, and then extends through the hook 226.

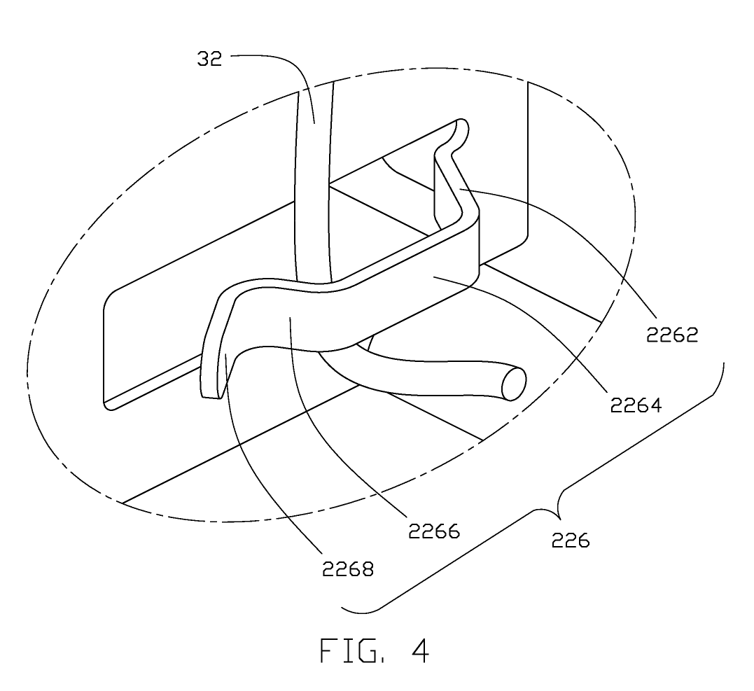

Referring also to FIG. 4, each hook 226 includes a base portion 2262, a receiving portion 2264, a stopper portion 2266, and a guide portion 2268 connected sequentially. The base portion 2262 extends outward from the assembly bracket 22. The receiving portion 2264 is connected to a free end of the base portion 2262, and extends substantially parallel to the assembly bracket 22. The stopper portion 2266 is connected to the receiving portion 2264, and extends close to the assembly bracket 22. The guide portion 2268 is connected to the stopper portion 2266, and extends away from the assembly bracket 22. A joint of the stopper portion 2266 and the receiving portion 2264 is near to the assembly bracket 22. A receiving space is formed between the receiving portion 2264 and the assembly bracket 22, for receiving the power cable 32. The joints where the base portion 2262 meets the receiving portion 2264, the receiving portion 2264 meets the stopper portion 2266, and the stopper portion 2266 meets the guide portion 2268 are all smoothly curved but may also be more sharply angled to realize the function of the hook 226.

In order to manage the power cable 32 of the fan 30, the guide portion 2268 is flexed away from the assembly bracket 22 and the power cable 32 is slid into the receiving space. The power cable 32 is positioned at a side of the opening and attached to the assembly bracket 22. The guide portion 2268 is let and the hook 226 rebounds to an initial state. The power cable 32 is blocked by the stopper portion 2266 from moving in front of the opening of the assembly bracket 22 and interfering with airflow.

In this embodiment, the power cables 32 of the fans 30 are clasped by the corresponding hooks 226 with a simple structure, and located at the side of the openings, for ensuring the normal dissipation of heat in the computer enclosure 10. It is needless to use binding accessories to bind the power cables 32, thereby reducing the cost while maintaining order in the computer enclosure 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable management apparatus for managing a power cable of a fan, comprising:
an assembly bracket attached to the fan; and
a hook protruding from the assembly bracket, for clasping the power cable, the hook comprising:
a base portion extending away from the assembly bracket;
a receiving portion extending from the base portion, the receiving portion and the assembly bracket cooperatively forming a receiving space for extension of the power cable therethrough;
a stopper portion extending close to the assembly bracket from the receiving portion, for blocking the power cable escaping from the receiving space; and
a guide portion connected to the stopper portion and extending away from the assembly bracket, for the power cable sliding into the receiving space.

2. The cable management apparatus as described in claim 1, wherein an arcuate portion is formed between the base portion and the receiving portion of the hook.

3. The cable management apparatus as described in claim 1, wherein an arcuate portion is formed between the stopper portion and the receiving portion of the hook.

4. The cable management apparatus as described in claim 1, wherein an opening is formed on the assembly bracket corresponding to the fan, for dissipating heat, the hook is disposed adjacent to the opening and the power cable is located at one side of the opening when the power cable is received in the receiving space of the hook.

5. The cable management apparatus as described in claim 4, wherein the fan is mounted between the assembly bracket and the other bracket parallel to the assembly bracket, a cutout is defined in the assembly bracket at an upper corner of the opening, the power cable of the fan rides over the assembly bracket through the cutout, and then extends through the hook.

6. A fan assembly comprising:
a fan having a power cable;
a pair of assembly brackets for receiving the fan therebetween, an opening defined in each assembly bracket in alignment with the fan for communicating the airflow;
a hook disposed at a side of the opening of the assembly bracket, the hook extending up from the assembly bracket with a free end extending back closely adjacent to the assembly bracket, a receiving space being defined between the hook and the assembly bracket for receiving the power cable of the fan and restricting the power cable moving in front of the opening of the assembly bracket.

7. The cable management apparatus as claimed in claim 6, wherein a cutout is defined in the assembly bracket at an upper corner of the opening, the hook is located at a lower corner of the opening, the power cable of the fan rides over the assembly bracket through the cutout, and then extends through the hook.

8. An apparatus comprising:
a housing for receiving a heat generating device therein, the housing comprising a bottom plate;
a plurality of fans, each of the fans having a power cable;
a first plate extending from the bottom plate, the first plate having a plurality of first air-permeable sections;
a second plate extending from the bottom plate, the second plate having a plurality of second air-permeable sections aligned with the respective first air-permeable sections, the second plate having a first end and an opposite second end adjacent to the bottom plate, the second plate having a plurality of cutouts defined in the first end and a plurality of cable holders arranged on an inner surface thereof which faces away from the first plate, adjacent to the second end thereof for holding the power cables extending therethrough; and
a plurality of partition walls interconnected between the first plate and the second plate, the first plate, the second plate and the partition walls cooperatively forming a plurality of receiving rooms with the plurality of fans received therein;
wherein the first and second air-permeable sections are located at opposite sides of the receiving rooms, and the power cable of each of the fans extends from the respective receiving room to the respective cable holder on the inner surface of the second pale via the respective cutout, the cutouts and the cable holders cooperatively route each of the power cables along a straight line outside the air-permeable sections.
